(19) United States
(12) Patent Application Publication
(10) Pub. No.: US 2002/0124471 A1
(43) Pub. Date: Sep. 12, 2002

(54) Reusable vacuum lid

(76) Inventors: Curt L. Anderson, Pleasanton, CA (US); Brad Nelson, San Ramon, CA (US); Mark Lowe, Danville, CA (US); Alberto Lam, San Jose, CA (US)

Correspondence Address: Sheldon R. Meyer, FLIESLER DUBB MEYER & LOVEJOY LLP, Fourth Floor, Four Embarcadero Center, San Francisco, CA, 94111-4156, US

(21) Appl. No.: 10/081,382

(22) Filed: Feb. 22, 2002

Related U.S. Application Data
(60) Provisional application No. 60/271,119, filed on Feb. 23, 2001.

(51) Int. Cl. E06B 3/32

(52) U.S. Cl. 49/463

(57) ABSTRACT

The present invention relates generally to vacuum lids, and in particular, vacuum lids that are compatible with containers to preserve food stored in the container. An embodiment of the invention includes a top surface with an access aperture, a plurality of raised members of varying heights, and a removable raised member that covers a container valve. A vacuum is applied to the container valve, wherein air from the container is removed from the container. The container is then sealed with a membrane, thereby holding a vacuum inside the container.

### CLAIM OF PRIORITY

This application claims priority from provisional application entitled “REUSABLE VACUUM LID”, Application No. 60/271,119, filed Feb. 23, 2001, and which application is incorporated by reference.

### FIELD OF THE INVENTION

The present invention relates generally to vacuum lids. More particularly, the present invention relates to vacuum lids that are compatible with containers to preserve food stored in the containers.

### BACKGROUND

Vacuum packaging food maintains the freshness and flavor of the food three to five times longer than food packaged with conventional storage methods. This improvement is because the amount of oxygen available for interaction with the food is reduced as a result of the vacuum. Thus, microorganisms that require oxygen to grow, such as bacteria and yeast, affect food stored in a vacuum less than food stored using conventional methods. Additionally, vacuum packed foods that are frozen are less affected by freezer burn because there is less cold, dry air to dehydrate the food.

The excess air that accompanies food packed using conventional packaging methods can have a variety of effects on the packaged food. For instance, dry foods can absorb moisture from the atmosphere, thereby becoming soggy. Yet, moist foods can become dry when packaged using conventional methods because air absorbs moisture from the moist food.

An example of a dry food is sugar. When sugar is stored such that moisture from the air can be absorbed, the sugar can harden into a solid block. Such a block is unappealing at the very least. Furthermore, a pound of sugar in the form of a single block is very difficult to use. If the sugar had been packaged in a vacuum, then moisture from the atmosphere could not be absorbed by the sugar. Thus, the sugar would remain in granular form and not turn into a solid block.

An example of a moist food is bread. When bread is stored in such a way as to allow exposure to the atmosphere, the bread tends to dry out and become hard and crusty. If, however, the bread was stored in a vacuumed packed storage container, then the atmosphere could not absorb the bread's moisture. Thus, the bread would maintain the proper amount of moisture and stay fresh and soft.

Bread, however, also suffers from microorganisms like bacteria, yeast, and mold growths due to temperature changes and excess moisture. Storing bread with a conventional packaging method gives the microorganisms access to the atmosphere, thereby permitting the microorganisms to grow. Consequently, the bread becomes unsuitable for consumption. Storing the bread in a vacuum prevents the atmosphere from depositing any new microorganisms or reacting with any existing microorganisms. Thus, the vacuum packaging allows the bread to maintain its freshness.

Yet another example of a food stored in conventional packaging devices is food that is high in fats and oils, such as butter. When food like butter is exposed to the atmosphere, over time becomes rancid, causing an unpleasant taste and smell. If the butter had been packaged in a vacuum, then the butter could not react with the atmosphere and turn rancid. Hence, the butter stored in a vacuum would remain fresh longer than if it had been packaged using a conventional packaging method.

There are several types of home vacuum packaging systems currently available in the marketplace. For instance, there are manually operated vacuum pumps. These systems typically consist of a small, manually-operated pump which can be used to extract air from a container. Although they do not completely remove the air from the container, they do help food last longer. Another example of a home vacuum system is a bag sealer that includes a fan. Such a systems uses a small rotary fan to extract some air out of a plastic bag before the bag is sealed. Several different bag configurations are available in the market for such a bag sealer/fan system. For instance, one such system uses a polyethylene bags. Other bag sealer/fan system use sheets of plastic from which bags of different lengths can be made. This variable bag system “welds” the seams of the plastic sheets with a heated wire bag-sealing mechanism, thereby forming a closed bag. However, the fans in these home vacuum packaging systems do not have the ability to create a vacuum. This can be seen because the plastic used for the containers will loosely form around the contours of the food in the bag, but it will be obvious that air remains in the bag. Also, the strength of the seal and the material used for the bag in these home vacuum packaging systems will determine whether any air, atmosphere, or oxygen can re-enter the bag.

Another type of home vacuum packaging systems uses an electric pump systems. These systems are the only storage systems that eliminate exposure to oxygen. They use electric-powered piston pumps to first extract air from a container. Then, the container is sealed to prevent any air, atmosphere, or oxygen from re-entering the sealed container. A consumer using such a home vacuum packaging systems can easily see that a vacuum is formed, when the container used to seal the food is a bag, because the bag will shape itself tightly around the food. Yet, when the container is more ridged, like a jar or a glass dish, a change in the physical shape of the container cannot be seen when the vacuum is present.

### SUMMARY OF THE INVENTION

It is an object of an embodiment of the present invention to create a vacuum lid compatible with, for example, ovenware containers and storage containers. Such a vacuum lid can be used to create a vacuum seal with the container, thereby preventing air from re-entering the container after being sealed. Another object of an embodiment of the invention is a vacuum lid that forms a container support surface when the lid seals the container under vacuum. The vacuum lid with a container support surface permits several containers to be stacked on top of each other where each container is covered with a vacuum lid. Yet another object of an embodiment of the present invention is a vacuum lid that is reusable.

### BRIEF DESCRIPTION OF THE DRAWINGS

FIG. 1 depicts a top perspective view of an embodiment of the invention.

FIG. 2 depicts a top perspective view of an embodiment of the invention illustrating an access aperture.

FIG. 3 depicts a top perspective view of an embodiment of the invention illustrating a vacuum plug inserted into a removable raised member access aperture.

FIG. 4 depicts a cross-section of an embodiment of the invention illustrating a gasket groove and a port valve assembly.

FIG. 5A depicts a cross-section of an embodiment of the invention illustrating a container valve.

FIG. 5B depicts a perspective view of an embodiment of a membrane of an embodiment of the invention.

FIG. 6 depicts a partial cut-away view of an embodiment of the invention illustrating a container valve and a vacuum release device.

FIG. 7 depicts another perspective view of the embodiment of the invention illustrated in FIG. 6.

FIG. 8 depicts a cross-section of an embodiment of the invention that illustrates a container valve with a removable raised member and a vacuum plug.

FIG. 9 depicts a top perspective view of a removable raised member of an embodiment of the invention.

FIG. 10 depicts a bottom perspective view of a removable raised member of an embodiment of the invention.

FIG. 11 illustrates a membrane of an embodiment of the invention.

### DETAILED DESCRIPTION OF THE INVENTION

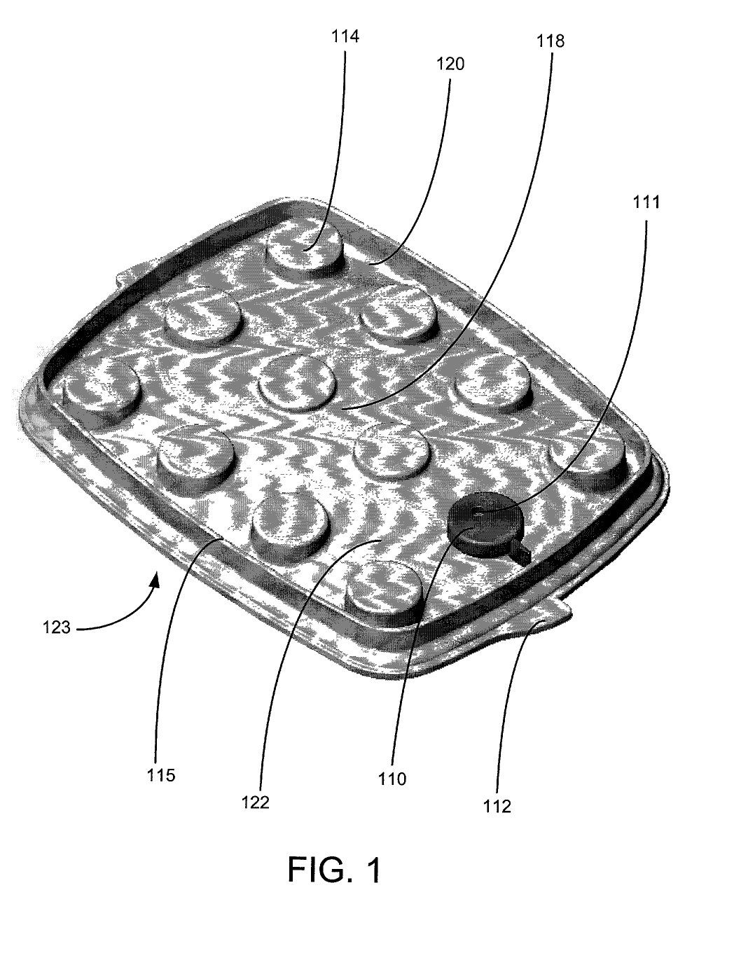

FIG. 1 depicts a top view of an embodiment of the invention. A removable raised member 110, a lid removal tab 112, a multiple raised member 114 and a lid catch 115 are all part of a lid 100. Lid 100 also includes a lid center 118, a lid perimeter 120, a top surface 122 and a bottom surface 123. Through removable raised member 110 is a vacuum access aperture 111.

Referring to FIG. 1, the lid 100 is slightly curved such that the lid center 118 is above the lid perimeter 120. The raised members 114 are of varying height extending above the top surface 122. The raised member closest to the perimeter 120 are taller than the raised member at the lid center. The upper most surface of the raised member 114 and/or the removable raised member 110 is that surface that is furthest from the top surface 122. The raised members 114 and removable raised member 110 are organized such that the upper most surface of each raised member 114 and removable raised member 110 form a container support surface which is preferably level or flat. The embodiment of the invention depicted in FIG. 1 shows eleven raised members 114 and one removable raised member 110.

In addition to providing the flat surface, removable raised member 110 also provides access through the lid 100 to a container upon which the lid 100 is affixed. In conjunction with the flat surface defined by the upper most portion of raised member 114 and removable raised member 110, the lid catch 115 provides support to a second container that can be stacked on top of lid 100. The lid removal tap 112 provides a device to disengage lid 100 from a container with which lid 100 is connected.

The lid 100, raised member 114 and removable raised member 110 can be made from materials that are generally ridged, but have some flexibility. Some such materials include polycarbonate and ABS plastic.

An alternate embodiment can include a removable raised member 110, that covers a substantial part of the lid 100 and no raised members 114. Thus, a flat surface can be provided by the removable raised member 110, itself. Another embodiment of the invention, however, can have the above enlarged removable raised member 110 and the lid perimeter 120 define a container support surface.

While the raised members 114 in FIG. 1 are circular in shape at their upper most surface, in an alternate embodiment, the raised members can be any other shape such as triangles, squares, rectangles, pentagons, stars, trees, leaves, pumpkins, clovers, hearts, etc. In yet another embodiment of the invention, the raised members can be ridges. For instance, a star shape pattern can be formed such that the center of the star pattern could begin at the lid center 118, or any other location on the lid 100, with the rays of the star being of varying height and covering the top surface 122, thereby forming a container support surface defined by the upper most portion of the star rays. Parallel ridges can also be provided which have less height at the center 118 and greater height about equal to the height of the lid catch 115 as the ridge approach the periphery of the lid 100.

In yet another embodiment of the invention, the lid 100 is flat such that the lid center 118 is generally on the same plane as the lid perimeter 120. In yet another embodiment of the invention, the upper most surface of raised members 114 and removable raised member 110 can form a plane when the lid 100 is connected with a container and a vacuum formed within the container.

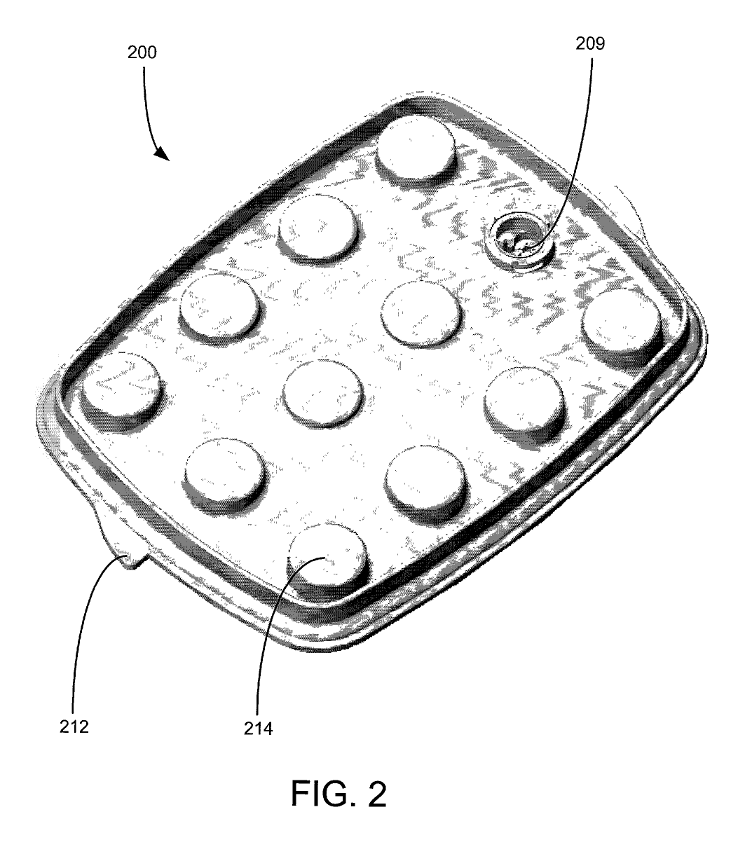

FIG. 2 depicts a top view of the embodiment of the invention of FIG. 1 illustrating an access aperture. An access aperture 209, a lid removal tab 212, and raised members 214 are all part of lid 200. The access aperture 209 provides access through lid 200 to a container that lid 200 is secured to. As in FIG. 1, a removable raised member 110 can cover the access aperture 209. It is between the removable raised member 110 and the access aperture 209 that the valving mechanism of the invention resides.

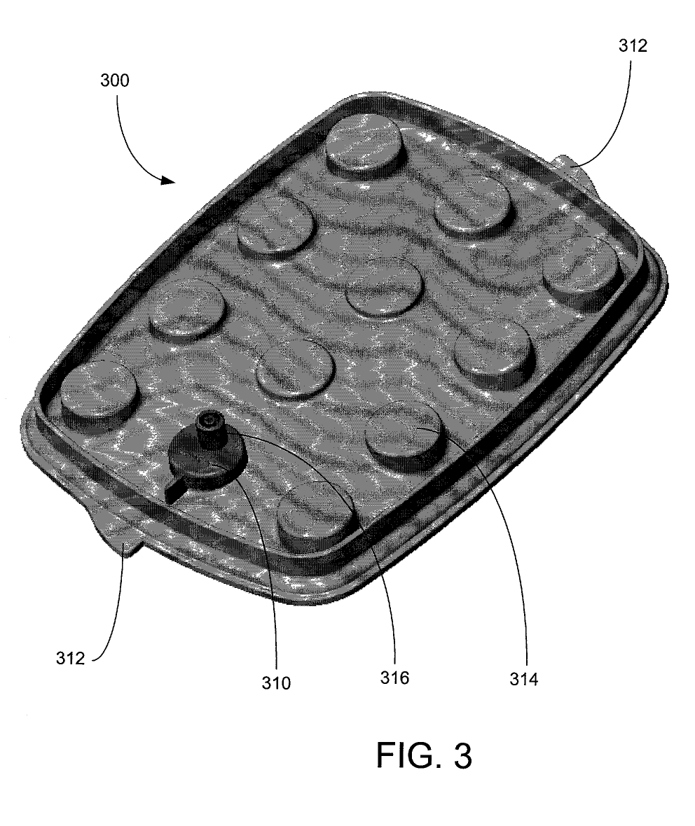

FIG. 3 depicts a top view of an embodiment of the invention, similar to FIGS. 1 and 2, illustrating a removable vacuum probe 316 inserted into a removable raised vacuum member access aperture. Removable vacuum probe 316 is connected with a source of vacuum for evacuating a container to which the lid 300 is affixed. Lid 300 has, in addition, raised members 314, lid removal tabs 312 and removable raised member 310.

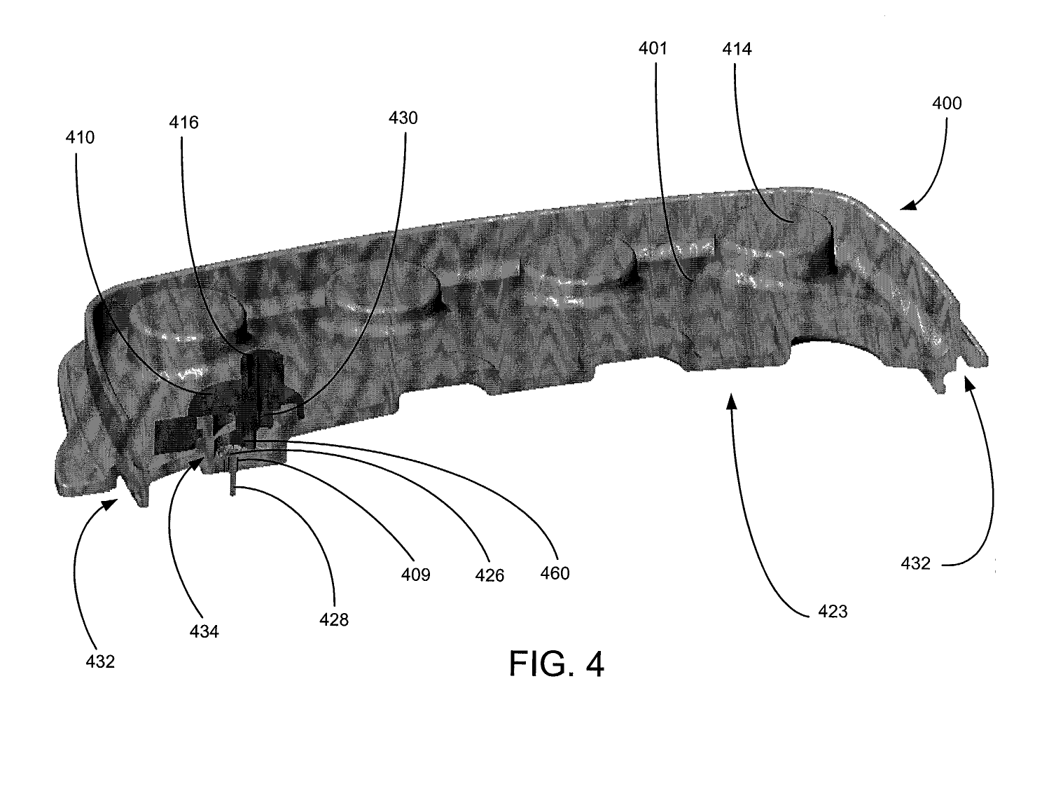

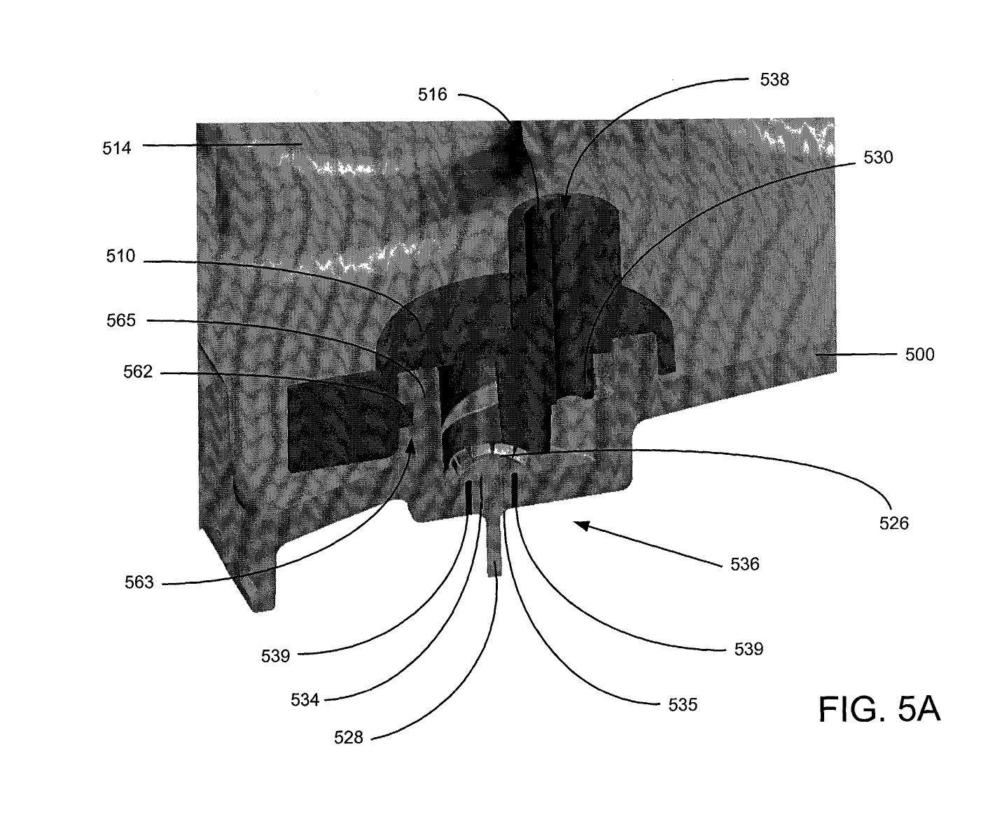

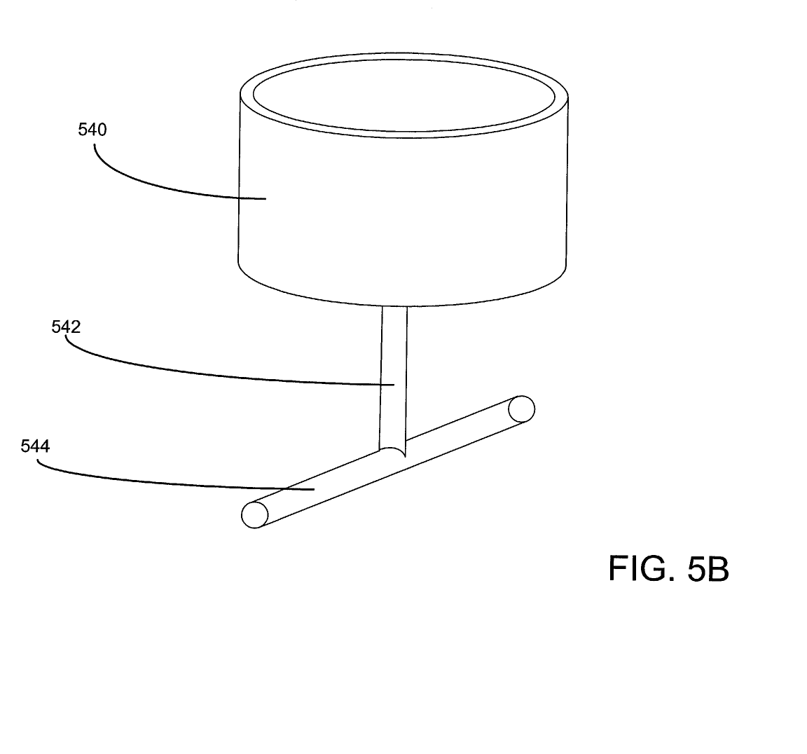

FIG. 4 depicts a cross-section of an embodiment of the invention illustrating a gasket groove and a port valve assembly. Lid 400 includes a lid top 401, a bottom surface 423, a gasket groove 132, an access aperture 409, raised members 414 and a removable raised member 410. Removable raised member 410 includes a vacuum release device 460. Removably insertable into the removable raised member 410 is a vacuum probe 416. Vacuum probe 416 includes a vacuum nose port 430. The access aperture 409 includes an access port 434. Connected with the access aperture 409 is a membrane 426. Membrane 426 is connected with a membrane stem 428 that extends through access aperture 409. All of the above features are depicted in greater detail in FIGS. 5 and 5A.

Gasket groove 432 provides a place for a gasket to connect with lid 400. The gasket improves the seal between lid 400 and a container connected with lid 400. The gasket is approximately equal to the circumference of the container shape. The better the seal between lid 400 and a container connected with lid 400, the better that a vacuum can be created inside the container.

FIG. 5A depicts a cross-section of an embodiment of the invention similar to FIGS. 1 to 4 illustrating the container valve 536. Lid 500 has raised members 514, the removable raised member 510 and the container valve 536. A vacuum probe 516 that includes a vacuum nose 530 is removably connected with the removable raised member 510. Typically vacuum probe 516 is permanently connected to a base which communicates with a source of vacuum. A vacuum channel 538 extends through the vacuum probe 516 and the vacuum nose 530 allowing access to the container valve 536. The container valve 536 includes a membrane 526. Connected with membrane 526 is a membrane stem 528 that extends through lid 500 by way of an access port 534. Membrane stem 528 fits loosely in a access port 534. Stopper 538 keeps membrane 526 in place. The membrane 526 can be manufactured from any number of different flexible materials. One such material is rubber.

In operation, vacuum probe 516 is connected with a vacuum that draws air through the container valve 536 and out of a container for which lid 500 is connected. As the vacuum is applied, membrane 526 is drawn towards the vacuum nose 530. Consequentially, membrane 526 permits air from the container to pass through access port 534 out of the container. Membrane stem 528 restricts the movement of membrane 526 such that membrane 526 does not come into a sealing engagement with the vacuum probe 516. After air is removed from the container, the vacuum source is disengaged, causing membrane 526 to be drawn back towards the container by the vacuum created in the container. Membrane 526, however, is prevented from fully entering the container by the size of the access port 534. As membrane 526 settles into place as a result of being drawn towards the container, a seal is formed with membrane 526 over access port 534, thereby sealing the container that now has a vacuum inside. It is also to be understood that in addition bores 539 can be provided in lid 500 or under the membrane 526. These bores also provide access to the inside of the container to which lid 500 is affixed. A vacuum can be drawn through bores 539 and when the vacuum source is turned off, the membrane 526 is drawn down by the vacuum inside of the container sealing off the bores 539.

FIG. 5B depicts a perspective view of an embodiment of a membrane of an embodiment of the invention similar to membrane 526. Membrane 540 is coupled with a membrane stopper 544 by a membrane stem 542. Assuming membrane 540 replaced membrane 526 in FIG. 5, membrane 540 is proximate to a first end of access port 534, membrane stem 542 is inside the access port 534, and membrane stopper 544 is proximate to a second end of access port 534. When a vacuum is applied through vacuum probe 516, membrane 540 can move towards vacuum probe 516. Membrane stopper 544 prevents membrane 540 from making a seal with vacuum probe nose 536. When the vacuum is removed, then membrane 540 seals access port 534 and prevents air from returning to the container. In one embodiment of the invention, the membrane 540 is generally cup shaped. In another embodiment of the invention, the membrane 540 is a generally flat surface.

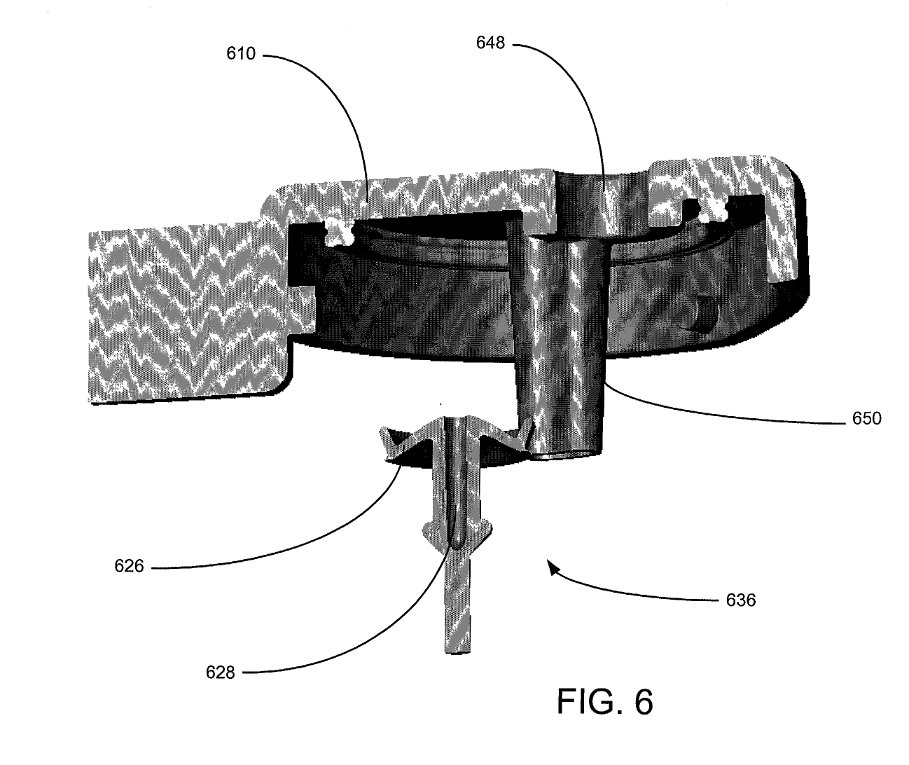

FIG. 6 depicts a partial cut-away view of an embodiment of the invention similar to FIG. 5 illustrating part of a container valve and a vacuum release device. A vacuum release device 650 is connected with a removable raised member 610 that includes a vacuum access port 648. The vacuum access port 648 provides access to a container valve 636. Container valve 636 includes a membrane 626 that is connected with a membrane stem 648. Vacuum access port 648 provides access for a vacuum probe such as vacuum probe 516 from FIG. 5. To break the seal that the container valve 636 makes with a container, the vacuum release device 650 is positioned to make contact with membrane 626. The membrane 626 is flexible such that once a predetermined force is applied by the vacuum release device 650 onto the membrane 626, then the membrane 626 deforms. The seal that the membrane 626 had previously made is then broken. Air can then return to the container from the atmosphere.

In one embodiment of the invention, the removable raised member 610 can rotate. In this embodiment, as the removable raised member 610 rotates, the vacuum release device 650 rotates. Through the rotation of the removable raised member 610, and consequentially the vacuum release device 650, contact is made with the membrane 626 by the vacuum release device 650. Continued rotation of the removable raised member 610 causes the vacuum release device 650 to push against the membrane 626 and thus the seal formed by the total membrane 626 to be broken, thereby exposing the container to the atmosphere. In one embodiment of the invention, the removable raised member 610 is rotated approximately by 25 degrees. Other embodiments can have rotations up to about 90 degrees. Although not depicted in FIG. 6, it is understood that a bead and recess arrangement can be formed between the removable member 610 and the lid to allow the removable member 610 to snap onto the lid and guide the removable member 610 as it rotates relative to the lid. For example, in FIG. 5A a guide 562 is formed in the inside of the skirt of removable raised member 510 and a recess 563 is formed in an upstanding collar 565 of the lid 500.

In yet another embodiment of the invention, the vacuum release device is a handle that extends through the removable raised member 610 such that the handle is accessible without removing the removable raised member 610 from a lid. In one embodiment of the invention, the handle can slid, thereby sliding the vacuum release device 650, such that the vacuum release device 650 makes contact with and deforms member 626, thereby breaking the seal and exposing the contents of the container to air in the atmosphere. In another embodiment of the invention, the vacuum release device 650 does not deform membrane 626, but rather, moves the membrane 626 such that an access port is exposed. Exposure of the access port permits air to enter the container from the atmosphere, thereby terminating the vacuum in the container.

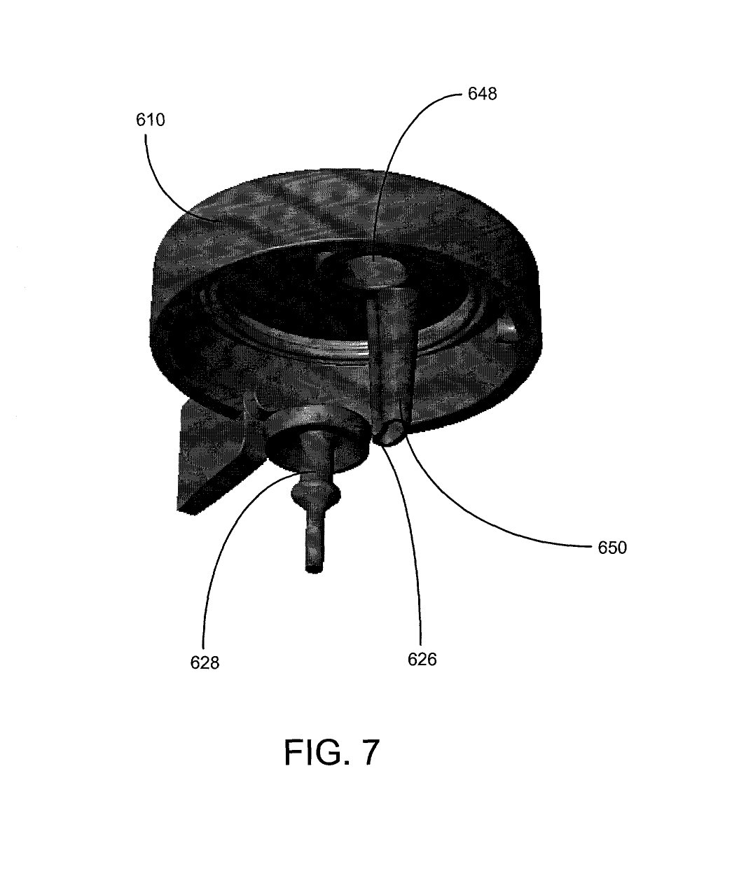

FIG. 7 depicts another perspective view of the embodiment of the invention illustrated in FIG. 6. Shown are a removable raised member 610 that includes a vacuum access port 648. The removable raised member 610 is connected with a vacuum release device 650. Container valve 636 includes a membrane 626 that is connected with a membrane stem 628.

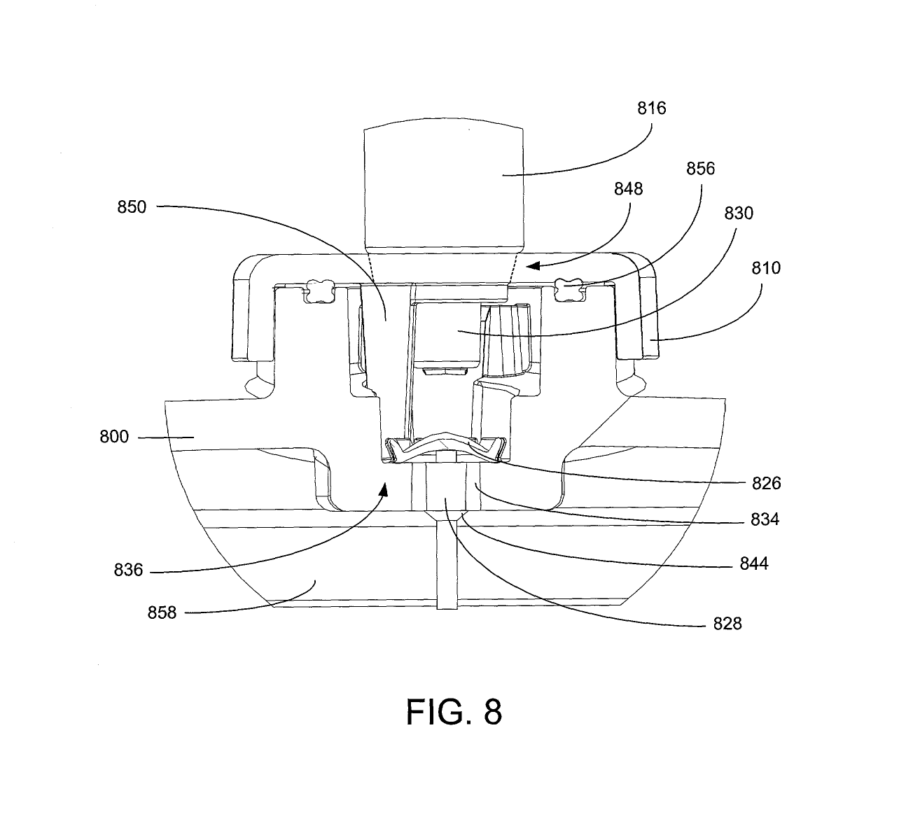

FIG. 8 depicts a cross section of an embodiment of the invention that illustrates a container valve with a removable raised member and temporarily positioned vacuum probe. A lid 800 is coupled with a container 858. A removable raised member seal 856, such as for example a gasket, couples a removable raised member 810 with the lid 800. Connected with the removable raised member 810 is a vacuum release device 850. The removable raised member 810 includes a vacuum port 848. A vacuum probe 816 that includes a vacuum nose 830 is temporarily connected with the removable raised member 810. The container valve includes a membrane 826. A membrane stem 828 couples the membrane 826 with a membrane stopper 844. The membrane 826 is connected with the lid 800 such that air flowing in either direction through an access port 834 is controlled.

The container valve 838 performs similarly to the container valves of FIG. 5, FIG. 6 and FIG. 7. Thus, as a vacuum source is connected with the vacuum probe 816, the membrane 826 is drawn towards the vacuum nose 830. Consequently, access port 834 is exposed allowing air to flow out of the container 858. When the vacuum source is disengaged from the vacuum probe, the membrane 826 seals the container valve 836, holding the vacuum inside the container 858. As in other embodiments, the membrane stopper 844 prevents the membrane 826 from making a seal with the vacuum probe 816 when a vacuum is connected with vacuum probe 816.

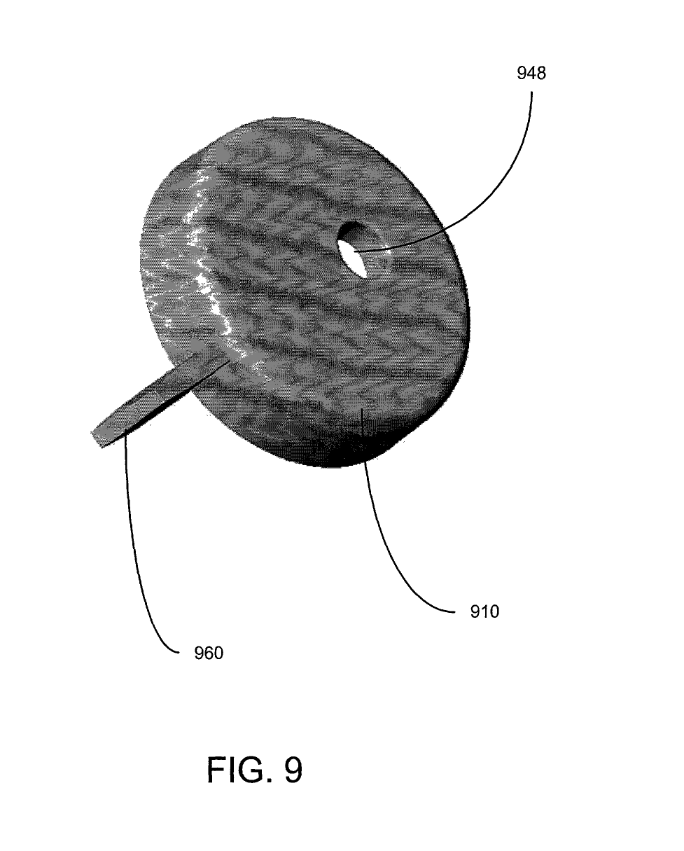

FIG. 9 depicts a top view of a removable raised member of an embodiment of the invention. Shown in FIG. 9 is a removable raised member 910 that includes a vacuum port 948. A lever 960 is connected with removable raised member 910. The lever 960 provides a device for rotating the removable raised member 910.

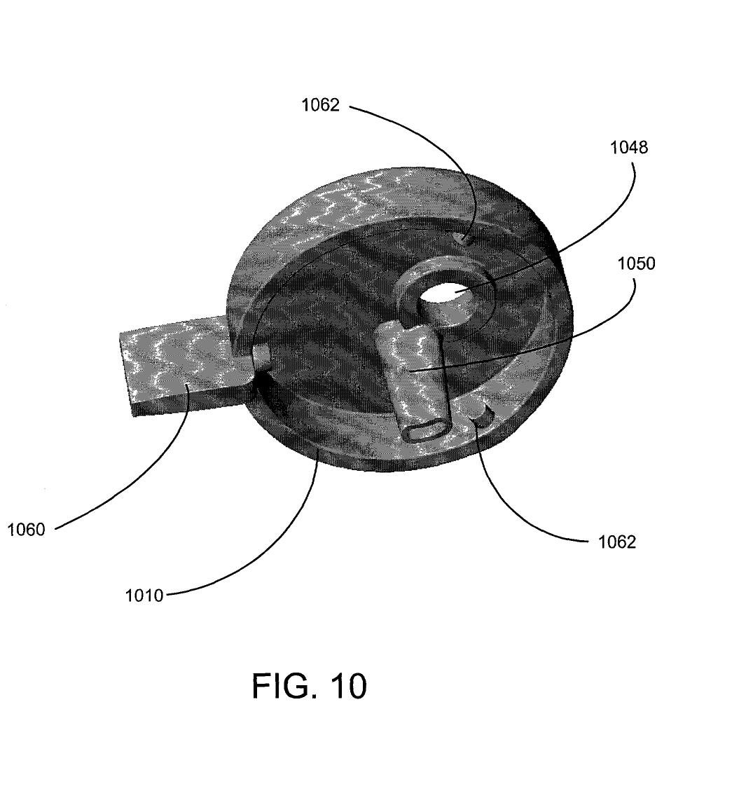

FIG. 10 depicts a bottom view of a removable raised member of an embodiment of the invention. A removable raised member 1010 includes a vacuum port 1048. A removable raised member 1010 is connected with a lever 1060, a vacuum release device 1050 and a guide 1062. The vacuum port 1048 provides access for a vacuum plug similar to the vacuum probe 816 of FIG. 8. The lever 1060 provides a device for rotating removable raised member 1010. Vacuum release device 1050 provides a device for releasing the vacuum inside a sealed container.

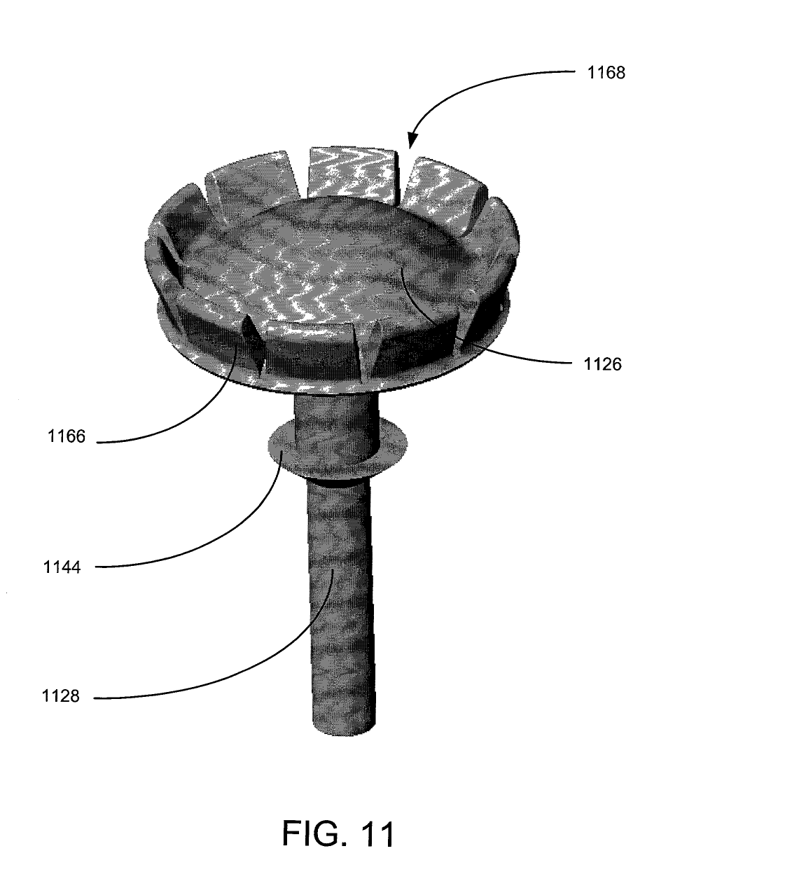

FIG. 11 illustrates an alternative membrane of an embodiment of the invention. A membrane stem 1128 couples a membrane 1126 with a membrane stopper 1144. The membrane includes a plurality of fins 1166 separated by a groove 1168. The fins 1166 are spaced along the perimeter of the membrane 1126 and generally extending upwardly from the membrane 1126 and away from the membrane stopper 1144. The membrane 1126 can also be described as having a shape similar to the crown.

It is to be understood that all of the above embodiments are disassembleable for cleaning by the user.

The foregoing description of preferred embodiments of the present invention has been provided for the purposes of illustration and description. It is not intended to be exhaustive or to limit the invention to the precise forms disclosed. Many modifications and variations will be apparent to the practitioner skilled in the art. The embodiments were chosen and described in order to best explain the principles of the invention and its practical application, thereby enabling others skilled in the art to understand the invention for various embodiments and with various modifications that are suited to the particular use contemplated. It is intended that the scope of the invention be defined by the following claims and their equivalence.

We claim:

1. A vacuum lid comprising:
a top surface which is convex;
a plurality of raised members extending upwardly from the convex top surface;
the raised members being of varying height in order to define a flat platform adjacent to the top surface; and
said to surface associated with a peripheral edge adapted to engage a container.

2. The reusable vacuum lid of claim 1 wherein:
the top surface has a center portion, and wherein the height of the raised members adjacent to the center portion is less than the height of the raised members adjacent to the peripheral edge.

3. The vacuum lid of claim 1 wherein:
one of said raised members houses a vacuum valve.

4. The vacuum lid of claim 3 wherein:
said one raised members that houses said vacuum valve is removable.

5. The vacuum lid of claim 1 wherein:
said raised members are hollow.

6. The vacuum lid of claim 1 wherein:
said raised members are rounded.

7. A vacuum lid comprising:
a top surface which is convex;
a plurality of raised members extending upwardly from the convex top surface;
the raised members being of varying height in order to define a flat platform adjacent to the top surface;
a peripheral edge adapted to engage a container;
the top surface has a center portion, and wherein the height of the raised members adjacent to the center portion is less than the height of the raised members adjacent to the peripheral edge; and
one of said raised members houses a vacuum valve.

8. The vacuum lid of claim 7 wherein:
said one raised members that houses said vacuum valve is removable.

9. The vacuum lid of claim 8 wherein:
said raised members are hollow.

10. The vacuum lid of claim 8 wherein:
said raised members are rounded.

11. The vacuum lid of claim 1 wherein:
at least some of the raised members have side walls of varying heights.

12. The vacuum lid of claim 8 wherein:
at least some of the raised members have side walls of varying heights.

13. The vacuum lid of claim 1 wherein said raised members are cylindrical in shape and at least some of the raised members have a side wall that varies in height.

14. The vacuum lid of claim 8 wherein said raised members are cylindrical in shape and at least some of the raised members have a side wall that varies in height.

15. The vacuum lid of claim 1 wherein:
said top surface has a center portion and the height of said raised members increases as the distance that the raised members radiate out from the center portion.

16. The vacuum lid of claim 8 wherein:
said top surface has a center portion and the height of said raised members increases as the distance that the raised members radiate out from the center portion.

17. A vacuum valve for a lid that is adapted for covering a container, comprising:
a raised member movably connected to a lid;
a first access port provide thorough said raised member;
a second container access port provide through said lid;
a valve membrane having a first position that seals said second container access port and a second position that opens said container access port;
wherein said raised member houses said valve membrane; and
wherein said raised member has an extension that can engage said valve member as said raised member is rotated relative to said lid in order to dislodge said first position in order to break the seal between the valve member and said second container access port.

18. The vacuum valve of claim 17 wherein:
said valve membrane has an upstanding member that is engagable by said extension in order to dislodge said valve membrane.

19. The vacuum valve of claim 17 wherein:
said valve membrane a plurality of upstanding tabs extending therefrom.

20. The vacuum valve of claim 17 wherein:
said valve membrane is a ring of upstanding tabs extending therefrom.

21. The vacuum valve of claim 17 wherein said lid includes:
a top surface which is convex;
a plurality of additional raised members extending upwardly from the convex top surface;
the additional raised members being of varying height in order to define a flat platform adjacent to the top surface; and
said to surface associated with a peripheral edge adapted to engage a container.

22. The vacuum valve of claim 17 wherein said lid includes:
a top surface which is convex;
a plurality of additional raised members extending upwardly from the convex top surface;
the additional raised members being of varying height in order to define a flat platform adjacent to the top surface;
a peripheral edge adapted to engage a container; and
the top surface has a center portion, and wherein the height of the additional raised members adjacent to the center portion is less than the height of the additional raised members adjacent to the peripheral edge.

23. A vacuum valve for a lid that is adapted for covering a container, comprising:
a housing member movably connected to a lid;
a first access port provide thorough said housing member;
a second container access port provide through said lid;
a valve membrane having a first position that seals said second container access port and a second position that opens said container access port;
wherein said housing member houses said valve membrane; and
wherein said housing member has an extension that can engage said valve member as said housing member is rotated relative to said lid in order to dislodge said first position in order to break the seal between the valve member and said second container access port.

24. The vacuum valve of claim 23 wherein:
said valve membrane has an upstanding member that is engagable by said extension in order to dislodge said valve membrane.

25. The vacuum valve of claim 23 wherein:
said valve membrane a plurality of upstanding tabs extending therefrom.

26. The vacuum valve of claim 23 wherein:
said valve membrane is a ring of upstanding tabs extending therefrom.

27. The vacuum valve of claim 23 wherein said lid includes:
a top surface which is convex;
a plurality of raised members extending upwardly from the convex top surface;
the raised members being of varying height in order to define a flat platform adjacent to the top surface; and
said to surface associated with a peripheral edge adapted to engage a container.

28. The vacuum valve of claim 17 wherein said lid includes:
a top surface which is convex;
a plurality of raised members extending upwardly from the convex top surface;
the additional members being of varying height in order to define a flat platform adjacent to the top surface;
a peripheral edge adapted to engage a container; and
the top surface has a center portion, and wherein the height of the raised members adjacent to the center portion is less than the height of the raised members adjacent to the peripheral edge.

29. The vacuum valve of claim 17 wherein:
said valve membrane includes a valve stem and a valve stopper extending from said valve stem; and
said valve stem is disposed in said second container access port with said valve stopper retaining said valve stem in said second container access port.

30. The vacuum valve of claim 23 wherein:
said valve membrane includes a valve stem and a valve stopper extending from said valve stem; and
said valve stem is disposed in said second container access port with said valve stopper retaining said valve stem in said second container access port.

31. A reusable vacuum lid, comprising:
a top surface including an access aperture;
a container valve connected with the top surface and proximate to the access aperture; and
a removable raised member connected with the top surface, wherein the removable raised member covers the access aperture.

32. The reusable vacuum lid of claim 31, wherein:
the container valve includes a membrane; and
the membrane is coupled with a membrane stopper.

33. The reusable vacuum lid of claim 32, wherein:
the membrane is coupled with a membrane stem.

34. The reusable vacuum lid of claim 33, wherein the membrane is cup shaped.

35. The reusable vacuum lid of claim 33, wherein the membrane is disk shaped.

36. The reusable vacuum lid of claim 33, including:
a bottom surface;
wherein the access aperture has a top end proximate to the top surface and a bottom end proximate to the bottom surface;
wherein the membrane stem includes a first end and a second end; and
wherein the membrane stem passes through the access aperture such that the first end of the membrane stem is proximate to the top end of the access aperture and the second end of the membrane stem is proximate to the bottom end of the access aperture.

37. The reusable vacuum lid of claim 36, wherein:
the membrane is connected with the first end of the membrane stem and the membrane stopper is connected with the second end of the membrane stem.

38. The reusable vacuum lid of claim 31, wherein:
the removable raised member includes a vacuum access port.

39. The reusable vacuum lid of claim 31, wherein:
the lid includes a lid perimeter.

40. The reusable vacuum lid of claim 39, wherein:
the upper surface of the removable raised member and the lid perimeter form a container support surface.

41. The reusable vacuum lid of claim 31, wherein:
the removable raised member is generally disk shaped.

42. The reusable vacuum lid of claim 31, including:
a plurality of raised fixed members of varying heights.

43. The reusable vacuum lid of claim 42, wherein:
the upper surface of the raised member and the upper surface of the removable raised members form a container support surface.

44. The reusable vacuum lid of claim 42, wherein:
the raised fixed members are generally disk shaped.

45. The reusable vacuum lid of claim 42, wherein:
the raised members end include a ridge.

46. A reusable vacuum lid, comprising:
a top surface including an access aperture;
a plurality of raised members of varying heights, each with an upper surface extending from the top surface;
wherein one of the plurality of raised members of varying heights is a removable raised member extending from the top surface;
the removable raised member includes a vacuum port; and
a container valve connected with the top surface and proximate to the access aperture, wherein the removable raised member covers the container valve and the vacuum port provides access to the container valve through the removable raised member.

47. The reusable vacuum lid of claim 46, wherein:
the container valve includes a membrane and the membrane includes a plurality of membrane wings separated by membrane grooves.

48. The vacuum lid of claim 1, further including:
a container to which the lid can be engaged.

49. The vacuum lid of claim 7 further including:
a container to which the lid can be engaged.

50. The vacuum lid of claim 12 further including:
a container to which the lid can be engaged.
